(19) United States
(12) Patent Application Publication
(10) Pub. No.: US 2009/0070873 A1
(43) Pub. Date: Mar. 12, 2009

(54) SAFE WEB BASED INTERACTIONS

(75) Inventors: R. Preston McAfee, San Marino, CA (US); David M. Pennock, Monroe Township, NJ (US)

Correspondence Address: BRINKS HOFER GILSON & LIONE / YAHOO! OVERTURE, P.O. BOX 10395, CHICAGO, IL, 60610, US

(73) Assignee: YAHOO! INC., Sunnyvale, CA (US)

(21) Appl. No.: 11/853,447

(22) Filed: Sep. 11, 2007

(51) Int. Cl. G06F 21/00; G06F 15/16

(52) U.S. Cl. 726/23; 715/234; 726/22

(57) ABSTRACT

A system is described for providing safe web based interactions. The system may include a memory, an interface, and a processor. The memory may store a request and a web page. The interface may be operative to communicate with a user and a third party server. The processor may be operatively connected to the memory and the interface and may receive a request from the user for a web page provided by the third party server. The processor may retrieve the web page and determine if malicious data is associated with the web page. If malicious data is determined to be associated with the web page the processor may disable the malicious data. The processor may modify the web page so that subsequent interactions with the web page are redirected to the processor, through the interface. The processor may provide the web page to the user, via the interface.

### TECHNICAL FIELD

The present description relates generally to a system and method, generally referred to as a system, for providing safe web based interactions, and more particularly, but not exclusively, to providing a safe environment for searching and browsing the world wide web (“web”).

### BACKGROUND

Malware may include software designed to infiltrate or damage a computer system without the computer user's informed consent. Malware may include computer viruses, worms, Trojan horses, spyware, adware, or any other malicious or unwanted software. A user's computer may be “infected” with malware when the user visits a malicious web page which, unbeknownst to the user, installs or otherwise executes the malware on the computer. While the web page may seem innocuous, surreptitious malware may be executed when the user's web browser loads the web page. Alternatively, malware may be executed when a user downloads and installs software from a malicious web page or through other user interactions with the web page.

The prevalence of malware has led to the development of malware detection software. The developed malware detection software may be installed on a user's computer. When the user performs a search on a supported search engine the software may, for example, consult a “hot list” of web sites known to promulgate malware to advise the user as to whether the web pages referenced in the search results may contain malware. The user may then make a determination as whether to browse the web pages in the search results or not. However, the software may not disable or prevent the malware from running on the user's computing device. Thus, if the user decides to browse to a web page, against the software's advisement, the user may still be vulnerable to any malware that may exist on the page.

The existing malware detection software may be incapable of enabling the user to safely browse the web page by disabling the malware. In addition, many pages may contain malware capable of hiding from spider and robot programs, the detection methods that may be utilized by the existing malware detection software. Furthermore users may only utilize the malware detection software if the software has been installed on their computer or device. The software must be capable of being installed and maintained on each computer or device that the user may use to browse web pages. The malware detection software may not be available for non-traditional web browsing devices, such as the MICROSOFT XBOX©, and thus these devices may still be vulnerable to malware.

### SUMMARY

A system for providing safe web based interactions may include a memory, an interface, and a processor. The memory may be operatively connected to the processor and the interface and may store a request and a web page. The interface may be operatively connected to the memory and the processor and to communicate with a user and a third party server. The processor may be operatively connected to the memory and the interface and may receive a request from the user for a web page provided by a third party server. The processor may retrieve the web page requested by the user and process the web page to determine if malicious data may be associated with the web page. If malicious data is determined to be associated with the web page the processor may disable the malicious data associated with the web page. The processor may modify the web page so that subsequent interactions with the web page by the user are redirected to the processor, through the interface. The processor may provide the web page to the user, via the interface.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a block diagram of a general overview of a system for providing safe web based interactions.

FIG. 2 is block diagram of a simplified view of a network environment implementing the system of FIG. 1 or other systems for providing safe web based interactions.

FIG. 3 is a block diagram illustrating the server side components of the systems of FIG. 1 and FIG. 2, or other systems for providing safe web based interactions.

FIG. 4 is a flowchart illustrating the operations of the systems of FIG. 1 and FIG. 2, or other systems for providing safe web based interactions.

FIG. 5 is a flowchart illustrating the operations of preparing a web page for display to a user in the systems of FIG. 1 and FIG. 2, or other systems for providing safe web based interactions.

FIG. 6 is a flowchart illustrating the operations of cleaning malware from a web page in the systems of FIG. 1 and FIG. 2, or other systems for providing safe web based interactions.

FIG. 7 is a screenshot of a safe search results web page displayed to a user in the systems of FIG. 1 and FIG. 2, or other systems for providing safe web based interactions.

FIG. 8 is exemplary HTML code for displaying the safe search results page of FIG. 7, including a button to exit the safe browsing system, in the systems of FIG. 1 and FIG. 2, or other systems for providing safe web based interactions.

FIG. 9 is a screenshot of a search results web page after a user has exited the safe browsing system in the systems of FIG. 1 and FIG. 2, or other systems for providing safe web based interactions.

FIG. 10 is a screenshot of a safe content provider web page displayed to a user in the systems of FIG. 1 and FIG. 2, or other systems for providing safe web based interactions.

FIG. 11 is exemplary HTML code for displaying the safe content provider web page of FIG. 10, including a button to exit the safe browsing system, in the systems of FIG. 1 and FIG. 2, or other systems for providing safe web based interactions.

FIG. 12 is a screenshot of a content provider web page after a user has exited the safe browsing system in the systems of FIG. 1 and FIG. 2, or other systems for providing safe web based interactions.

FIG. 13 is an illustration of a general computer system that may be used in the system of FIG. 3 or other systems for providing safe web based interactions.

### DETAILED DESCRIPTION

A system and method, generally referred to as a system, may relate to providing safe web based interactions, and more particularly, but not exclusively, to providing a safe environment for searching and browsing the web. The principles described herein may be embodied in many different forms. For example, providing safe web based interactions may refer to preventing malicious code from being processed and/or executed by a user's computer. Conversely, an unsafe interaction may be an interaction where malicious code is processed and/or executed by a user's computer, either with, or without, the user's knowledge. Alternatively or in addition, providing safe web based interactions may refer to preventing inappropriate, or objectionable, content from downloading and/or displaying on a user's computer.

The system and method may fill a need for a system capable of preventing or disabling malware, preferably at a server level, thereby allowing a user to safely browse non-malicious web content on any web capable device.

The system may enable users to safely browse web pages by removing or disabling malicious code, or malware, associated with a web page before a user browses the page on a web capable device. The system may allow a service provider, such as a search engine provider, to redirect a user's web traffic through the service provider's servers. The service provider may then remove or disable malware associated with pages requested by a user before allowing the pages to be served to the user's web capable device. Thus, the system may be capable of removing and/or disabling malware independent of the type of web capable device used by the user.

The system may enable a service provider to replace advertisements from a web page which may not generate revenue for the service provider with advertisements which may generate revenue for the service provider. The web page with the revenue producing advertisements may then be served to a user.

The system may enable a service provider to provide a customizable server side web browsing interface to a user, which the user may be able to access on any web capable device. The web browsing interface may enable a user to access bookmarks, button configurations, server-side scripts, or generally any customizable aspects of a web browser from any web capable device.

The system may enable a service provider to modify or format web pages for display on the particular web capable device used by a user. If a user is browsing the web from a mobile device, the system may allow a service provider to remove images from the web page, to reduce the amount of data transferred, or generally reformat the web page for proper display on the specific device of the user.

The system may enable a service provider to customize web pages served to a user in any manner identified by the user. The system may provide the user with an interface for identifying the customizations the user desires. For example, the user may be able to identify words or phrases to be highlighted on any page served to the user. The service provider may be able to highlight the words or phrases before serving the page to the user. The system may allow a user to add notes or “sticky-tags” to a page. Each subsequent access of the page may include the notes or “sticky-tags.”

The system may allow users to designate shortened URLs which may reference a longer URL. The service provider may then serve the page referenced by the longer URL when a user browses to the shortened URL. Furthermore the system may allow a user to reference a highlighted page or notated page through a shortened URL.

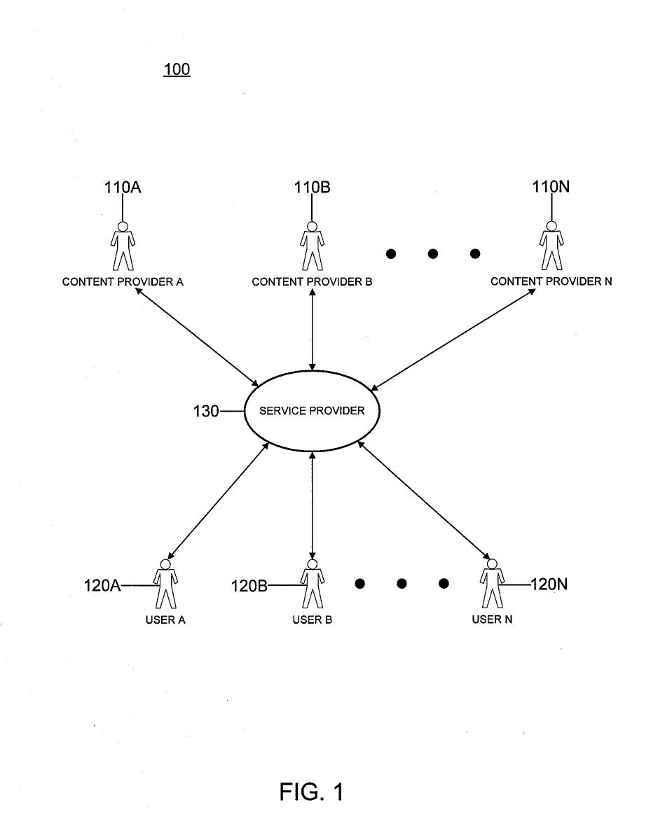

FIG. 1 provides a general overview of a system 100 for providing safe web based interactions. Not all of the depicted components may be required, however, and some implementations may include additional components. Variations in the arrangement and type of the components may be made without departing from the spirit or scope of the claims as set forth herein. Additional, different or fewer components may be provided.

The system 100 may include one or more content providers 110A-N, such as an entity that makes content available on a web page published on the world wide web, a service provider 130, such as a search engine marketing service provider, and one or more users 120A-N, such as web surfers or consumers. The service provider 130 may implement an advertising campaign management system incorporating an auction based and/or non-auction based advertisement serving system. The users 120A-N may search for the content provided by the content providers 110A-N through the service provider 130.

The service provider 130 and the content providers 110A-N may display advertisements of advertisers. The advertisers may pay the service provider 130 and/or the content providers 110A-N to serve, or display, advertisements of their goods or services, such as on-line advertisements, on their web pages via a network, such as the Internet. The advertisements may include sponsored listings, banners ads, popup advertisements, or generally any way of attracting the users 120A-N to the web sites of the advertisers.

The amount the advertisers may pay the service provider 130 and/or content providers 110A-N may be based on one or more factors. These factors may include impressions, click throughs, conversions, and/or generally any metric relating to the advertisement and/or the behavior of the users 120A-N. The impressions may refer to the number of times an advertisement may have been displayed to the users 120A-N. The click throughs may refer to the number of times the users 120A-N may have clicked through an advertisement to a web site of one of the advertisers. The conversions may refer to the number of times a desired action was taken by the users 120A-N after clicking though to a web site of an advertiser. The desired actions may include submitting a sales lead, making a purchase, viewing a key page of the site, downloading a whitepaper, and/or any other measurable action. If the desired action is making a purchase, then the advertiser may pay the service provider 130 and/or the content providers 110A-N a percentage of the purchase.

The users 120A-N may be consumers of goods or services who may be searching for web content, such as content on the web page of one of the content providers 110A-N. Alternatively or in addition the users 120A-N may be machines or other servers. The users 120A-N may supply information describing themselves to the service provider 130, such as the location, gender, or age of the users 120A-N, or generally any information that may be required for the users 120A-N to utilize the services provided by the service provider 130.

The users 120A-N may access the services provided by the service provider 130 through a web application, such as web browser or any other application capable of displaying web content. The application may be implemented with a processor such as a personal computer, personal digital assistant, mobile phone, or any other machine capable of implementing a web application.

In operation, one of the users 120A-N, such as the user A 120A, may use the web application to navigate to a safe search engine web page (“page”) provided by the service provider 130. The safe search engine page may exist in parallel with a traditional search engine page. The safe search engine may be offered to the users 120A-N on a subscription or other fee-for services basis. The safe search engine page may enable the user A 120A to search and access the web pages of the content providers 110A-N without the risk of malware infecting their computing device. When the user A 120A performs a search via the safe search engine, the system 100 may act as an intermediary, redirecting the resultant web traffic of the user A 120A through the servers of the service provider 130, referred to as the “main servers.” The traffic may be redirected by returning the search results in an invisible frame and replacing all of the uniform resource locators (“URLs”) in the search results with URLs redirecting the traffic through the servers of the service provider 130. The service provider 130 may then retrieve the actual web page the user A 120A wishes to browse, scan the page for malware, process the page, such as by replacing the URLs on the page as will be described, and serve or otherwise provide the page to the user A 120A. The service provider 130 may provide a mechanism on the web page, such as a button, which may allow the user to exit the safe browsing system 100 and return to traditional web browsing.

If the service provider 130 detects malware on a page the service provider 130 may notify the user A 120A of the malware, and provide the user A 120A with the option of removing the malware from the page or otherwise neutralizing it or browsing the page with the malware intact. Malware “on a page” may refer to malware being included in the underlying code which defines the visual representation of the page, or in other code which may be executed by the loading, interpretation or execution of the page code or which may be triggered by the mere access, e.g. sending of a get request, to the URL of the particular page.

If the user A 120A requests the malware be removed/neutralized from the page the service provider 130 may attempt to remove or neutralize the malware. If the service provider 130 is unable to remove or neutralize the malware from the page the service provider 130 may notify the user A 120A that the malware could not be removed or neutralized, and may provide the user A 120A with the option navigating away from the page.

Routing the web traffic of the user A 120A through the servers of the service provider 130 may further allow the service provider 130 to provide a wide range of services to the user A 120A and to the advertisers. The service provider 130 may be able to modify the web pages, before serving them to the user A 120A, such as by formatting the pages for display on the particular web browsing device of the user A 120A. The service provider 130 may be able to determine the device the user A 120A is using to browse the web pages, such as by utilizing the HTTP user agent field of the requests generated by the device, and then modify the web pages to ensure they display properly on the device. For example, if the user A 120A is browsing web pages from a mobile device, certain web pages may not display properly on the mobile device. The service provider 130 may be able to re-format the pages for proper display on the mobile device.

The service provider 130 may be able to render a customizable thin client browser to the user A 120A and display the web pages desired by the user A 120A in the thin client browser. The user A 120A may be able to customize any aspect of the thin client browser, such as bookmarks, buttons, server side scripts, or generally any customizable aspects of a web browser. The customizations of the user A 120A may be stored in an account or user profile of the user A 120A by the service provider 130. The user A 120A may then access their customized web browser on future visits to the safe search page. The thin client browser may be available to the user A 120A on any device capable of displaying web content.

The service provider 130 may also be able to provide the user A 120A with page customization services, such as highlighting words on a page or posting a note on a web page. The service provider 130 may store the highlighting or notes of the user A 120A in an account associated with the user A 120A and may display the highlighting or notes to the user A 120A on subsequent visits to the web page.

The service provider 130 may also be able to provide several services to the user A 120A through replacing the URLs on the web pages with URLs redirecting the user A 120A through the servers of the service provider 130. The service provider 130 may be able to utilize the URL replacement to enable the user A 120A to map longer URLs to shortened URLs. The user A 120A may be able to create custom URLs for a particular web page of one of the content providers 110A-N, or for a web page highlighted or notated by the user A 120A.

The service provider 130 may be able to provide value to, and generate value from, advertisers by redirecting web traffic through the servers of the service provider 130. The service provider 130 may be able to track the specific web behavior of a user A 120A, such as every web page visited by the user A 120A and generally any other data capable of describing the behavior of the user A 120A. The service provider 130 may store data describing the behavior of the user A 120A in a database. The user behavior data may later be accessed to determine advertisements which may relate to the historical behavior of the user A 120A, such as the interests or spending habits of the user A 120A.

The service provider 130 may be able to scan web pages to determine if the web pages contain advertisements which may generate revenue for the service provider 130. If the page does not contain advertisements which may generate revenue for the service provider 130 the service provider 130 may replace the advertisements with advertisements which may generate revenue. The service provider 130 may scan the content of the page and may add an advertisement to the page that matches the content or the known behavior of the user A 120A.

More detail regarding the aspects of auction-based advertising systems, as well as the structure, function and operation of the service provider 130, as mentioned above, can be found in commonly owned U.S. patent application Ser. No. 10/625,082, filed on Jul. 22, 2003, entitled, “TERM-BASED CONCEPT MARKET”; U.S. patent application Ser. No. 10/625,000, file on Jul. 22, 2003, entitled, “CONCEPT VALUATION IN A TERM-BASED CONCEPT MARKET” filed on Jul. 22, 2003; U.S. patent application Ser. No. 10/625,001, filed on Jul. 22, 2003, entitled, “TERM-BASED CONCEPT INSTRUMENTS”; and U.S. patent application Ser. No. 11/489,386, filed on Jul. 18, 2006, entitled, “ARCHITECTURE FOR AN ADVERTISEMENT DELIVERY SYSTEM,” all of which are hereby incorporated herein by reference in their entirety. The systems and methods herein associated with ad campaign management may be practiced in combination with methods and systems described in the above-identified patent applications incorporated by reference.

Alternatively or in addition the system 100 may be implemented through the use of a proxy server. In this instance the user A 120A may browse the web through a proxy server supplied by the service provider 130. The user A 120A may need to install software on their web capable device to properly interface with the proxy server.

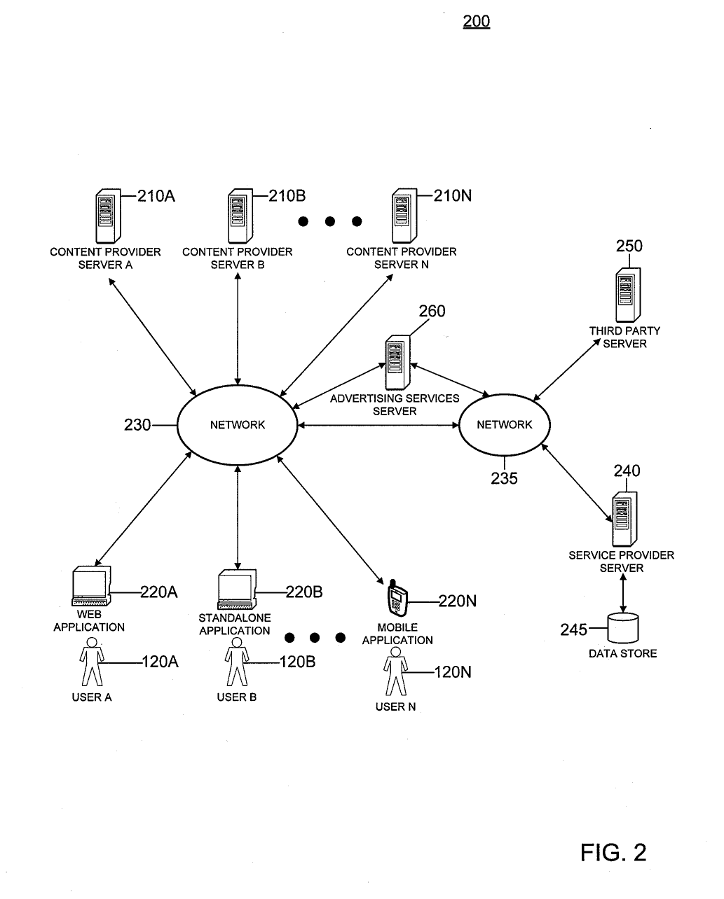

FIG. 2 provides a simplified view of a network environment 200 implementing the system of FIG. 1 or other systems for providing safe web based interactions. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The network environment 200 may include one or more content provider servers 210A-N, and one or more web applications, standalone applications, mobile applications 220A-N, which may collectively be referred to as client applications for the users 120A-N, or individually as a user client application. The network environment 200 may also include a network 230, a network 235, a service provider server 240, a data store 245, a third party server 250, and an advertising services server 260.

Some or all of the advertisement services server 260, service provider server 240, and third-party server 250 may be in communication with each other by way of network 235. The advertisement services server 260, third-party server 250 and service provider server 240 may each represent multiple linked computing devices. Multiple distinct third party servers, such as the third-party server 250, may be included in the network environment 200. A portion or all of the advertisement services server 260 and/or the third-party server 250 may be a part of the service provider server 240.

The data store 245 may be operative to store data, such as data relating to interactions with the users 120A-N. The data store 245 may include one or more relational databases or other data stores that may be managed using various known database management techniques, such as, for example, SQL and object-based techniques. Alternatively or in addition the data store 245 may be implemented using one or more of the magnetic, optical, solid state or tape drives. The data store 245 may be in communication with the service provider server 240. Alternatively or in addition the data store 245 may be in communication with the service provider server 240 through the network 235.

The networks 230, 235 may include wide area networks (WAN), such as the internet, local area networks (LAN), campus area networks, metropolitan area networks, or any other networks that may allow for data communication. The network 230 may include the Internet and may include all or part of network 235; network 235 may include all or part of network 230. The networks 230, 235 may be divided into sub-networks. The sub-networks may allow access to all of the other components connected to the networks 230, 235 in the system 200, or the sub-networks may restrict access between the components connected to the networks 230, 235. The network 235 may be regarded as a public or private network connection and may include, for example, a virtual private network or an encryption or other security mechanism employed over the public Internet, or the like.

The content provider servers 210A-N may communicate with the service provider server 240 via the networks 230, 235. The service provider server 240 and the content provider servers 210A-N may communicate with the users 120A-N via the networks 230, 235, through the web applications, standalone applications or mobile applications 220A-N.

The web applications, standalone applications and mobile applications 220A-N, and content provider servers 210A-N, may be connected to the network 230 in any configuration that supports data transfer. This may include a data connection to the network 230 that may be wired or wireless. Any of the web applications, standalone applications and mobile applications 220A-N may individually be referred to as a client application. The web application 220A may run on any platform that supports web content, such as a web browser or a computer, a mobile phone, personal digital assistant (PDA), pager, network-enabled television, digital video recorder, such as TIVO®, automobile and/or any appliance or platform capable of data communications.

The standalone application 220B may run on a machine that may have a processor, memory, a display, a user interface and a communication interface. The processor may be operatively connected to the memory, display and the interfaces and may perform tasks at the request of the standalone application 220B or the underlying operating system. The memory may be capable of storing data. The display may be operatively connected to the memory and the processor and may be capable of displaying information to the user B 120B. The user interface may be operatively connected to the memory, the processor, and the display and may be capable of interacting with a user B 120B. The communication interface may be operatively connected to the memory, and the processor, and may be capable of communicating through the networks 230, 235 with the service provider server 240, content provider servers 210A-N, third party server 250 and advertising services server 260. The standalone application 220B may be programmed in any programming language that supports communication protocols. These languages may include: SUN JAVA®, C++, C#, ASP, SUN JAVASCRIPT®, asynchronous SUN JAVASCRIPT®, or ADOBE FLASH ACTIONSCRIPT®, amongst others.

The mobile application 220N may run on any mobile device that may have a data connection. The data connection may be a cellular connection, a wireless data connection, an internet connection, an infra-red connection, a Bluetooth connection, or any other connection capable of transmitting data.

The service provider server 240 and content provider servers 210A-N may include one or more of the following: an application server, a data store, such as the data store 245, a database server, a middleware server, and an advertising services server. The service provider server 240 may exist on one machine or may be running in a distributed configuration on one or more machines. The service provider server 240 may be referred to as the server. The service provider may implement a search engine marketing system and/or an advertising campaign management system. The service provider server 240 and the content provider servers 210A-N may receive requests from the users 120A-N and may serve pages to the users 120A-N based on their requests.

The third party server 250 may include one or more of the following: an application server, a data source, such as a database server, a middleware server, and an advertising services server. The third party server may implement a relevancy engine, a context matching engine, or any other third party application that may be used in a search engine marketing system and/or an advertising campaign management system. The third party server 250 may exist on one machine or may be running in a distributed configuration on one or more machines.

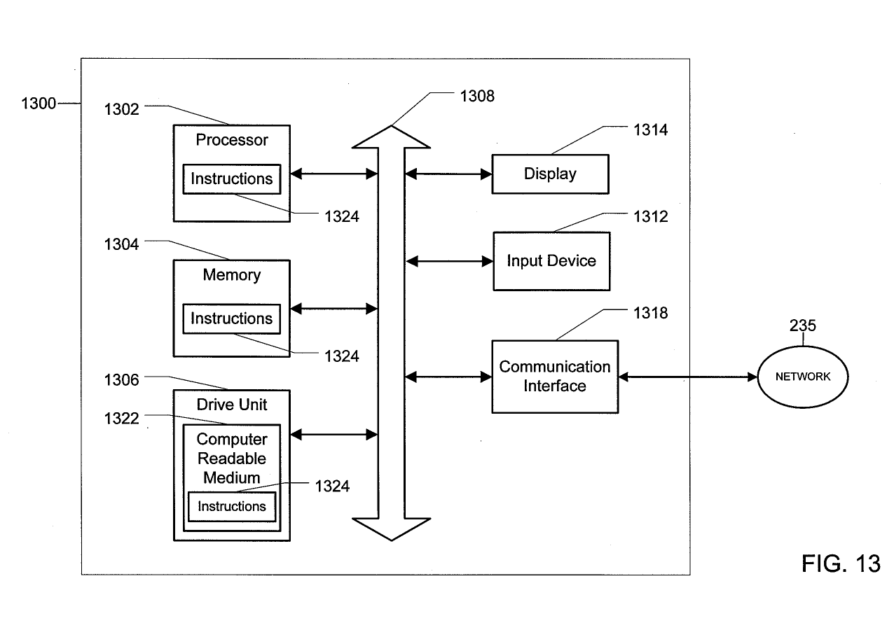

The service provider server 240, the third party server 250, the content provider servers 210A-N, and the advertising services server 260 may be one or more computing devices of various kinds, such as the computing device in FIG. 13. Such computing devices may generally include any device that may be configured to perform computation and that may be capable of sending and receiving data communications by way of one or more wired and/or wireless communication interfaces. Such devices may be configured to communicate in accordance with any of a variety of network protocols, including but not limited to protocols within the Transmission Control Protocol/Internet Protocol (TCP/IP) protocol suite. For example, the web application 220A may employ HTTP to request information, such as a web page, from a web server, which may be a process executing on the service provider server 240, the content provider servers 210A-N, or the third-party server 250.

There may be several configurations of database servers, such as the data store 245, application servers, middleware servers and advertising services servers included in the service provider server 240, or the third party server 250. Database servers may include MICROSOFT SQL SERVER®, ORACLE®, IBM DB2® or any other database software, relational or otherwise. The application server may be APACHE TOMCAT®, MICROSOFT IIS®, ADOBE COLDFUSION®, YAPACHE® or any other application server that supports communication protocols. The middleware server may be any middleware that connects software components or applications. The middleware server may be a relevancy engine, a context matching engine, or any other middleware that may be used in a search engine marketing system and/or an advertising campaign management system.

The application server on the service provider server 240, the third party server 250, or the content provider servers 210A-N, may serve pages, such as web pages to the users 120A-N. The advertising services server 260 may provide a platform for the inclusion of advertisements in pages, such as web pages. The advertising services server 260 may also exist independent of the service provider server 240 and the third party server 250. The advertisement services server 260 may be used for providing advertisements that may be displayed to users 120A-N on pages, such as web pages. The advertising services server 260 may implement a search engine marketing system and/or an advertising campaign management system.

The networks 230, 235 may be configured to couple one computing device to another computing device to enable communication of data between the devices. The networks 230, 235 may generally be enabled to employ any form of machine-readable media for communicating information from one device to another. Each of networks 230, 235 may include one or more of a wireless network, a wired network, a local area network (LAN), a wide area network (WAN), a direct connection such as through a Universal Serial Bus (USB) port, and the like, and may include the set of interconnected networks that make up the Internet. The networks 230, 235 may include any communication method by which information may travel between computing devices.

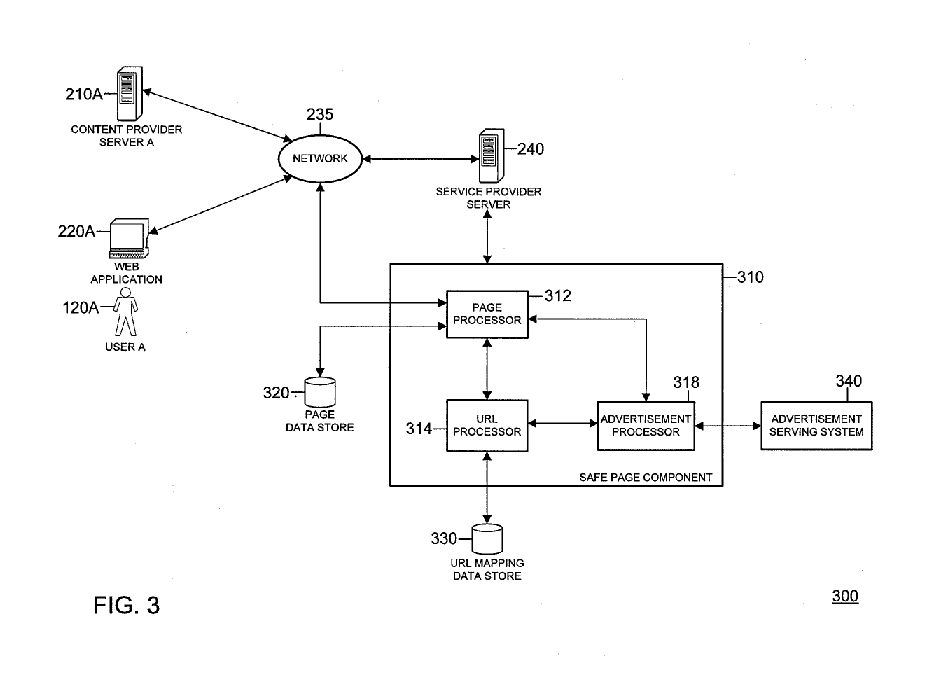

FIG. 3 illustrates the server side components of a system 300 for providing safe web based interactions. The system 300 may include a safe page component 310, responsible for ensuring that a page is safe to browse, a page data store 320, which may cache clean versions of web pages, a URL mapping data store 330, which may store URL mappings, an advertisement serving system 340, which may provide advertisements to be displayed on a page, the service provider server 240, the network 230, the content provider server A 210A, the web application 220A, and the user A 120A. The safe page component 310 may include a page processor 312, a URL processor 314, and an advertisement processor 318.

The safe page component 310 may be a component of the service provider server 240, or may exist independent of the service provider server 240 on one or more computing devices, such as the one illustrated in FIG. 13. The safe page component 310 may be operative to receive a URL from the service provider server 240, such as an encoded URL, and retrieve the page referenced by the URL. The safe page component 310 may be operative to detect malware on the page and disable or remove the malware. The safe page component 310 may be operative to perform the aforementioned page modifications, such as formatting a page for display on a specific device. Alternatively or in addition the safe page component 310 may communicate a safe page to the third party server 250, or a middleware server, to perform specific page modification functions. The safe page component 310 may be operative to communicate the modified page to the service provider server 240.

The URL processor 314 may be operative to encode and decode the URLs on a page. The URLs on a page may be encoded by the URL processor 314 to ensure each of the URLs redirects the user A 120A through the service provider server 240. The URL processor 314 may store the mapping between the original URL and the encoded URL in the URL mapping store 330. The URL processor 314 may be operative to decode an encoded URL by looking up the original URL in the URL mapping data store 330. The URL mapping data store 330 may be a data structure, such as a database, a hash table, or generally any data structure capable of mapping an encoded URL to a URL.

The page processor 312 may be operative to retrieve the web page desired by the user A 120A, such as a page of the content provider A 110A, and perform any necessary modifications to the page. The URL of the actual web page may be communicated to the page processor 312 by the URL processor. The page processor 312 may be operative to determine whether the page is cached in the page data store 320. If the page is not cached in the page data store 320 the page processor 312 may be operative to retrieve the page from the content provider server A 210A, via the network 230.

The page processor 312 may be operative to scan the page for malware and disable or remove malware from the page. Alternatively the page processor 312 may communicate with a third party server 250 for malware scanning and removal services. The third party server 250 may be specialized for performing malware scanning and removal.

The page processor 312 may be operative to modify the page, such as by reformatting the page, or otherwise processing the web page. Alternatively or in addition, the page processor 312 may communicate with a third party server 250 for specialized page modifications, such as formatting the page for a specific platform. For example, the page processor may communicate the page and the type of web capable device of the user A 120A to a YAHOO! SUSHI platform. The YAHOO! SUSHI platform may be specialized to format pages for proper display on a specific web capable device, particularly on specific mobile web capable devices.

The page processor 312 may be operative to attach code to the web page to catch any attempt by the user A 120A to access a page outside of the domain of the service provider server 240. The code may redirect the request through the service provider server 240 and may include data describing the URL desired by the user A 120A.

The advertisement processor 318 may be operative to determine whether a page contains advertisements that do not generate revenue for the service provider 130. If the page contains advertisements which do not generate revenue for the service provider the advertisement processor 318 may be operative to remove the non-revenue generating advertisements from the page. The advertisement processor 318 may also be operative to determine whether advertisements may be added to the page. Advertisements may be added to the page in lieu of empty space, in lieu of space made available by removing non-revenue generating advertisements, in a popup window, or generally in any manner which advertisements may be displayed through a page.

The advertisement processor 318 may be operative to communicate with the advertisement serving system 340 to retrieve advertisements for display on the page. The advertisement processor 318 may be operative to process the content on the page, or to access data describing the user A 120A or the behavior of the user A 120A. The content on the page or the data describing the user A 120A may be communicated to the advertisement serving system 340 to retrieve relevant advertisements. Alternatively or in addition the advertisement processor 318 may communicate the entire page and/or data describing the user A 120A to the advertisement serving system 340. The advertisement serving system 340 may process the page content, or the data describing the user A 120A, and communicate relevant advertisements to the advertisement processor 318.

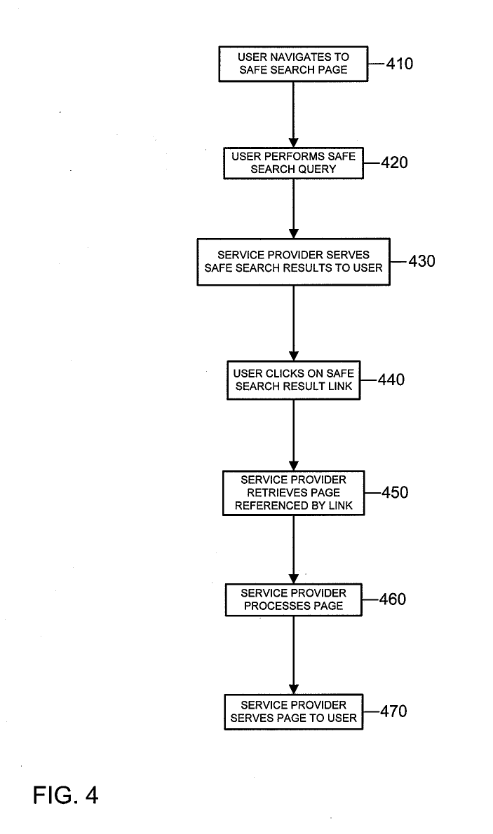

FIG. 4 is a flowchart illustrating the operations of the systems of FIG. 1 and FIG. 2, or other systems for providing safe web based interactions. At block 410 the user A 120A may navigate to a safe search web page provided by the service provider server 240. At block 420, the user A 120A may search for a query on the safe search web page. The service provider server 240 may generate a web page containing the search results of the query, which may include advertisements of the advertisers. The service provider server 240 may encode any URLs on the search results page to redirect any request of the user A 120A through the service provider server 240.

At block 430 the service provider server 240 may serve the safe search results page to the user A 120A. The safe search results page may be served to the user in an invisible frame. Alternatively or in addition the safe search results page may be served to the user in the original window, in a new window, or generally in any manner of serving pages to the web capable device of the user A 120A. At block 440 the user A 120A may click on a link on the search results page. The link may reference a web page of one of the content providers 110A-N, such as the content provider A 110A, however the underlying URL may be encoded to redirect the request through the service provider server 240. At block 450 the service provider server 240 may retrieve the page referenced by the link, either via the page data store 320, or via the content provider server A 210A.

At block 460 the service provider server 240 may process the page, such as by removing or disabling malware from the page and encoding the URLs on the page. Alternatively or in addition the service provider server 240 may format the page for proper display on the device of the user A 120A, or may retrieve page modifications previously stored by the user A 120A and apply the modifications to the page. At block 470 the service provider server 470 may serve the modified page to the user A 120A, such as through the invisible frame.

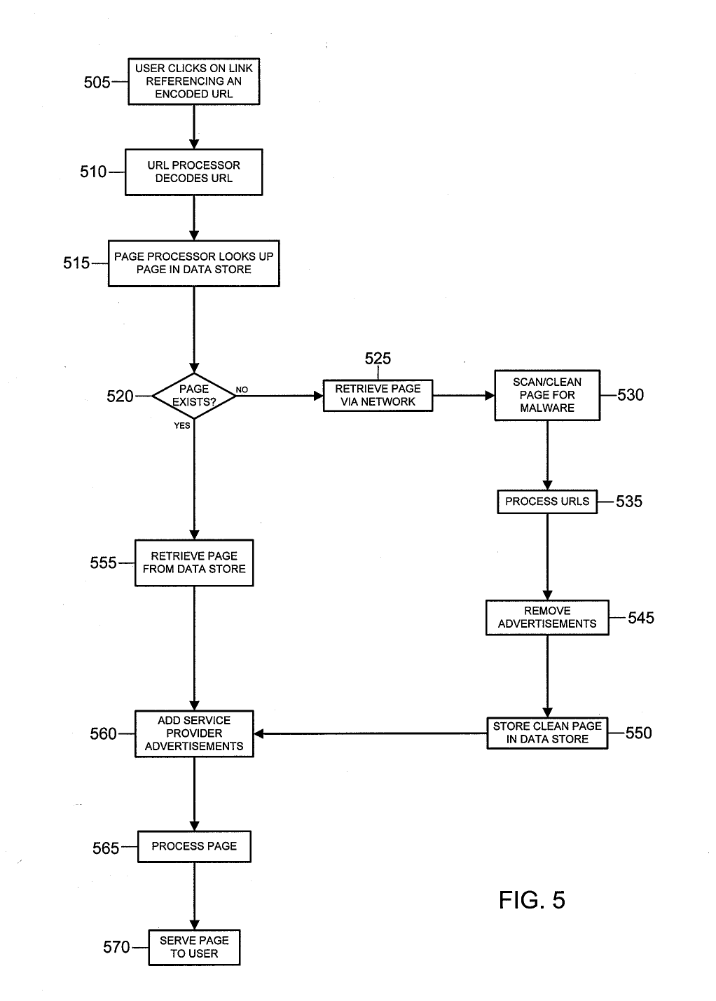

FIG. 5 is a flowchart illustrating the operations of preparing a web page for display to a user in the systems of FIG. 1 and FIG. 2, or other systems for providing safe web based interactions. At block 505 the user A 120A may click on a link representing a page of the content provider A 110A, but referencing an encoded URL redirecting the request through the service provider server 240. For example, the link may contain the text “DVD Movies, Videos and New Releases DVDs at DVDEmpire.com,” referencing the content provider “DVD Empire”; however, the underlying URL referenced by the link may be a URL redirecting the request through the service provider server 240. At block 510 the service provider server 240 may receive the request and may communicate the encoded URL to the URL processor 314. The URL processor 314 may decode the URL by looking up the actual URL mapped to the encoded URL in the URL mapping data store 330.

At block 515 the page processor 312 may attempt to look up the page referenced by the actual URL in the page data store 320. At block 520, if the page processor 312 determines a clean copy of the page is cached in the page data store 320, the system 100 may move to block 555. The clean copy of the page may already contain encoded URLs redirecting a request of the user A 120A through the service provider server 240. Alternatively or in addition, if the clean copy of the page does not contain encoded URLs the URL processor 314 may encode the URLs on the page.

The URL processor 314 may encode the URLs by replacing each URL on the web page with a URL that directs the user A 120A through the domain service provider server 240. For example, if the service provider server 240 domain is “foo.com,” the URL processor 314 may replace each URL with a URL starting with “foo.com,” thereby redirecting the request through the service provider server 240. The URL processor 314 may store the mapping between the original URL and the encoded URL in the URL mapping data store 330. The URL mapping data store 330 may then be later accessed to determine the actual web page requested by the user A 120A. By replacing each URL on the page with a URL redirecting the user A 120A through the service provider server 240, the service provider server 240 may ensure that the user A 120A only browses pages which have been scanned for malware by the service provider server 240.

At block 555 the page processor 312 may retrieve the clean copy of the page from the page data store 320. At block 560 the advertisement processor 318 may add revenue generating advertisements to the page. At block 565 the page processor 312 may process the page, such as reformatting the page for proper display on the web capable device of the user A 120A. At block 570 the service provider server 240 may serve the page to the user A 120A.

If, at block 520, a clean copy of the page does not exist in the page data store, the system 100 may move to block 525. At block 525 the page processor 312 may retrieve the page from the content provider server A 210A via the network 230. At block 530 the page processor 530 may scan the page for malware. If the page processor 530 detects malware the page processor 530 may remove or disable the malware. Alternatively or in addition the service provider server 240 may notify the user A 120A that the page contains malware and may ask the user A 120A if the malware should be removed or disabled. If the user A 120A chooses not to remove or disable the malware the page processor 312 may not remove or disable the malware. Alternatively or in addition, if the page processor 312 is unable to remove or disable the malware the service provider server 240 may notify the user A 120A that the malware could not be removed from the page. The user A 120A may be presented with the option to browse the page with malware present, or to browse away from the page.

At block 535 the URL processor 314 may encode the URLs on the page by mapping the original URLs with URLs redirecting the requests of the user A 120A through the service provider server 240. The URL processor 314 may store the URL mappings in the URL mapping data store 330. At block 545, the advertisement processor 318 may analyze the page to determine if the page contains any advertisements which do not generate revenue for the service provider 130. The advertisement processor 318 may remove any advertisements which do not generate revenue for the service provider 130. Alternatively, or in addition, the advertisement processor 318 may remove all advertisements from the page. Once the page has been cleaned of any malware, and has been stripped of any non-revenue generating advertisements, the page may be referred to as a “clean” page. Alternatively or in addition a clean page may be stripped of all advertisements, regardless of whether they generate revenue for the service provider 130.

At block 550 the page processor 312 may store the clean page in the page data store 320. The page data store 320 may store the clean page for a period of time determined by the service provider 130. The service provider 130 may have page data stores 320 located at strategic geographic locations around the world. The pages stored, or cached, in the page data stores 320 may be immediately served to the user A 120A, and may be utilized to improve the overall performance of the system 100.

Alternatively or in addition the safe page component 310 may retrieve, clean, and store the most frequently accessed pages, such as the top one thousand most frequently requested pages, in the page data stores 320. The most frequently accessed pages may then be immediately served to the users 120A-N. The process of retrieving, cleaning and storing the most frequently accessed pages may be referred to as batch processing.

At block 560 the advertisement processor 318 may add revenue generating advertisements to the page. At block 565 the page processor 312 may process the page, such as reformatting the page for proper display on the web capable device of the user A 120A. At block 570 the service provider server 240 may serve the page to the user A 120A.

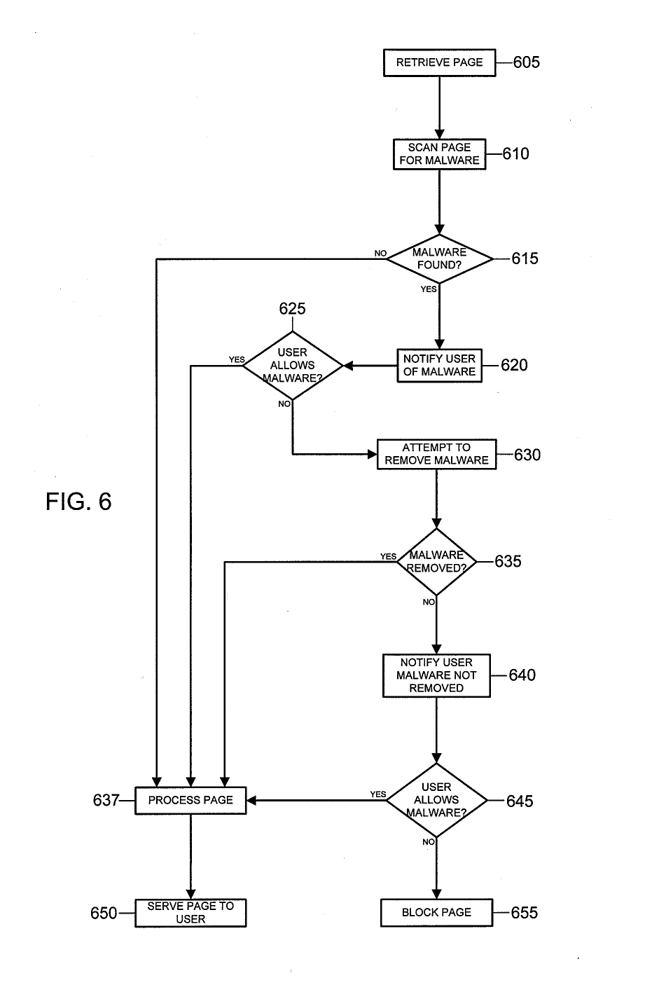

FIG. 6 is a flowchart illustrating the operations of cleaning malware from a web page in the systems of FIG. 1 and FIG. 2, or other systems for providing safe web based interactions. At block 605 the page processor 312 may retrieve the page requested by the user A 120A. At block 610 the page processor 312 may scan the page for malware, such as viruses, worms, Trojan horses, rootkits, backdoors, spyware, botnets, loggers, dialers, or generally any code that may be hostile, intrusive, or otherwise bothersome to the user A 120A. At block 615, if the page processor 312 finds malware on the page the system 100 may move to block 620. At block 620 the service provider server 240 may notify the user A 120A that the page contains malware. The service provider server 240 may communicate to the user A 120A the type of malware, and generally any information that may describe the malware. The service provider server 240 may retrieve additional information regarding the malware from a third party server 250, such as a web server specializing in malware. At block 625 the user A 120A may be given the option to allow the malware, and browse the page with the malware present, or have the service provider server 240 attempt to remove the malware. If the user A 120A chooses to allow the malware the system 100 may move to block 637. At block 637 the page may be further processed by the page processor 312, the URL processor 314, or the advertisement processor 318. Following the page processing the system 100 may move to block 650. At block 650 the service provider server 240 may serve the page, with the malware present, to the user A 120A via the network 230.

If, at block 625, the user A 120A elects to have the service provider 240 attempt to remove the malware the system may move to block 630. At block 630 the page processor 312 may attempt to remove the malware. The page processor 312 may attempt to remove the malware code, or the page processor may communicate the page to a third party server 250, such as a third party server specializing in removing malware. At block 635 the page processor 312 may determine whether the malware was successfully removed. If the malware was successfully removed the system 100 may move to block 637. At block 637 the page may be further processed by the page processor 312, the URL processor 314, or the advertisement processor 318. Following the page processing the system 100 may move to block 650. At block 650 the service provider server 240 may serve the page to the user A 120A via the network 230.

If, at block 635, the page processor 312 is unable to remove the malware, the system 100 may move to block 640. At block 640 the service provider server 240 may notify the user A 120A that the malware could not be removed. At block 645 the user A 120A may be given the option to allow the malware and browse the page with the malware present or have the service provider server 240 attempt to remove the malware. If the user A 120A chooses to allow the malware the system 100 may move to block 637. At block 637 the page may be further processed by the page processor 312, the URL processor 314, or the advertisement processor 318. Following the page processing the system 100 may move to block 650. At block 650 the service provider server 240 may serve the page, with the malware present, to the user A 120A via the network 230.

If, at block 645, the user A 120A chooses not to allow the malware, the system 100 may move to block 655. At block 655 the service provider server 240 may block the page from being served to the user A 120A. The user A 120A may be served a page containing information describing the malware. Alternatively or in addition the user A 120A may be returned to the page they were previously browsing.

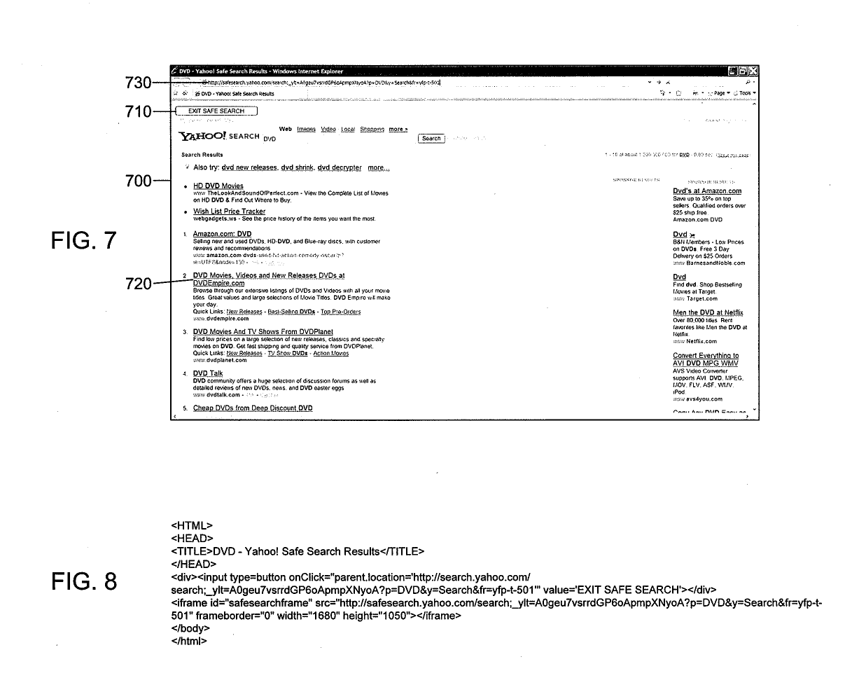

FIG. 7 is a screenshot of a safe search results web page 700 displayed to a user in the systems of FIG. 1 and FIG. 2, or other systems for providing safe web based interactions. The web page 700 may include an exit button 710, at least one link 720, such as a link to a web page of one of the content provider servers 210A-N, and a URL 730. When the user A 120A clicks on the exit button 710 the user A 120A may be exited from the safe browsing system 100 and may resume standard web browsing. The URL 730 may reference the service provider server 230 hosting the safe search browsing system 100.

FIG. 8 is exemplary HTML code for displaying the safe search results page of FIG. 7, including a button to exit the safe browsing system, in the systems of FIG. 1 and FIG. 2, or other systems for providing safe web based interactions. The HTML may be code capable of displaying the web page 700 of FIG. 7. The HTML code of FIG. 8 may utilize an invisible frame, or an HTML iframe element, to implement the safe browsing system 100. An invisible frame may refer to an HTML iframe element with the frameborder variable set to 0. Alternatively or in addition the web page 700 of FIG. 7 may be generated by the service provider server 240 without iframes or invisible frames.

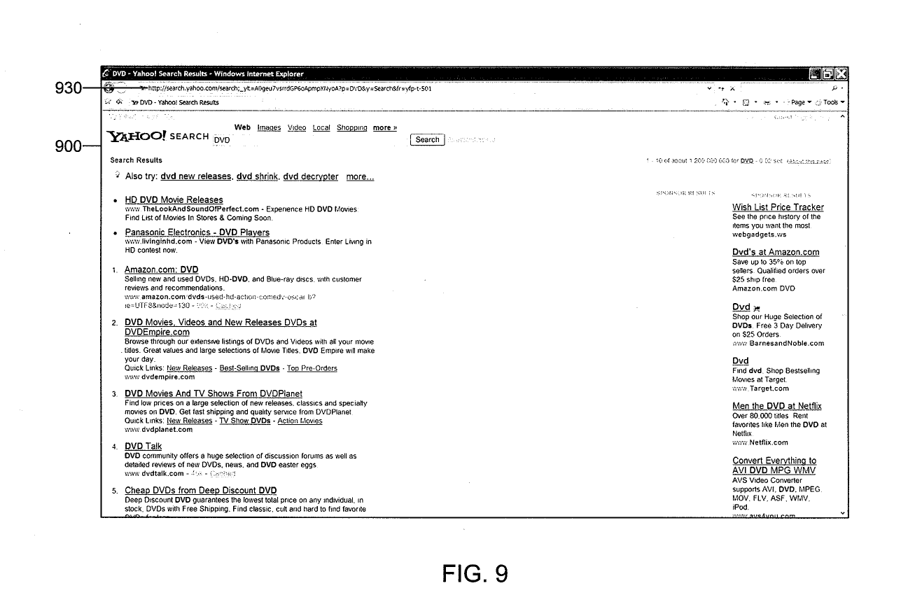

FIG. 9 is a screenshot of a search results web page 900 after a user has exited the safe browsing system in the systems of FIG. 1 and FIG. 2, or other systems for providing safe web based interactions. The web page 900 may include a URL 930. The URL 930 may reference a standard search engine. If the user A 120A clicks on the exit button 710 on the web page 700 of FIG. 7, the user A 120A may be exited from the safe browsing system 100. The user A 120A may then be returned to a standard web browsing page, such as the web page 900.

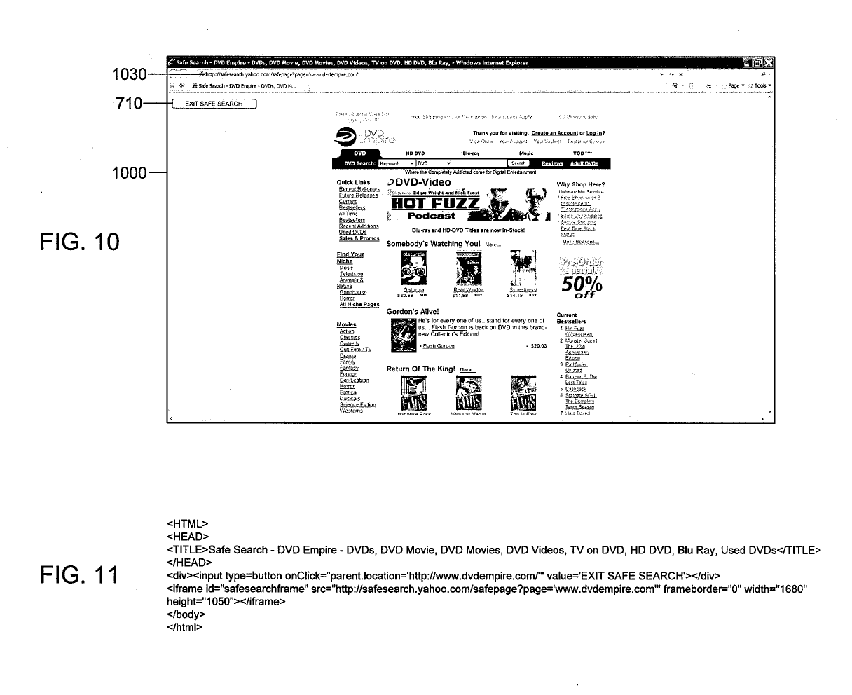

FIG. 10 is a screenshot of a safe content provider web page 1000 displayed to a user in the systems of FIG. 1 and FIG. 2, or other systems for providing safe web based interactions. The web page 1000 may include a exit button 710 and a URL 1030. The web page 1000 may be the web page of one of the content providers 110A-N. The web page 1000 may be served to the user A 120A when the user A 120A clicks on the link 720 on the web page 700. The web page 1000 may have been processed by the page processor 312 and the URLs may have been encoded by the URL processor 314. Thus, if the user A 120A were to click on a link on the web page 1000, the request of the user A 120A may be redirected through the service provider server 240. The URL 1030 of the web page 1000 may not reference the content provider server A 210A, but may reference the service provider server 240. The web page 1000 may be stored in the page data store 320. Malware that may exist on the version of the page served from the content provider server A 210A may have been removed.

FIG. 11 is exemplary HTML code for displaying the safe content provider web page of FIG. 10, including a button to exit the safe browsing system, in the systems of FIG. 1 and FIG. 2, or other systems for providing safe web based interactions. The HTML may be code capable of displaying the web page 1000 of FIG. 10. The HTML code of FIG. 11 may utilize an invisible frame, or an HTML iframe element, to implement the safe browsing system 100. An invisible frame may refer to an HTML iframe element with the frameborder variable set to 0. Alternatively or in addition the web page 1000 of FIG. 10 may be generated by the service provider server 240 without iframes or invisible frames.

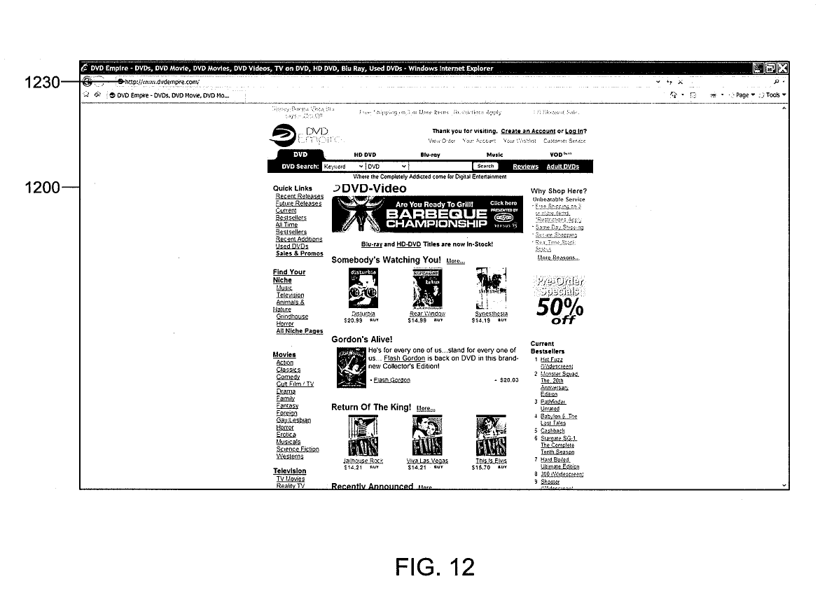

FIG. 12 is a screenshot of a content provider web page 1200 after a user has exited the safe browsing system in the systems of FIG. 1 and FIG. 2, or other systems for providing safe web based interactions. The web page 1200 may include a URL 1230. The URL 1230 may reference the content provider server A 210A. If the user A 120A clicks on the exit button 710 on the web page 1000 of FIG. 10, the user A 120A may be exited from the safe browsing system 100. The user A 120A may then be directed to the version of the web page 1200 that is hosted on the content provider server A 210A.

FIG. 13 illustrates a general computer system 1300, which may represent a service provider server 240, a third party server 250, an advertising services server 260, the content provider servers 210A-N, the safe search component 310, the page processor 312, the URL processor 314, the advertisement processor 318, the advertisement serving system 340, or any of the other computing devices referenced herein. The computer system 1300 may include a set of instructions 1324 that may be executed to cause the computer system 1300 to perform any one or more of the methods or computer based functions disclosed herein. The computer system 1300 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 1300 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 1324 (sequential or otherwise) that specify actions to be taken by that machine. In a particular embodiment, the computer system 1300 may be implemented using electronic devices that provide voice, video or data communication. Further, while a single computer system 1300 may be illustrated, the term “system” shall also be taken to include any collection of systems or sub-systems that individually or jointly execute a set, or multiple sets, of instructions to perform one or more computer functions.

As illustrated in FIG. 13, the computer system 1300 may include a processor 1302, such as, a central processing unit (CPU), a graphics processing unit (GPU), or both. The processor 1302 may be a component in a variety of systems. For example, the processor 1302 may be part of a standard personal computer or a workstation. The processor 1302 may be one or more general processors, digital signal processors, application specific integrated circuits, field programmable gate arrays, servers, networks, digital circuits, analog circuits, combinations thereof, or other now known or later developed devices for analyzing and processing data. The processor 1302 may implement a software program, such as code generated manually (i.e., programmed).

The computer system 1300 may include a memory 1304 that can communicate via a bus 1308. The memory 1304 may be a main memory, a static memory, or a dynamic memory. The memory 1304 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 1304 may include a cache or random access memory for the processor 1302. Alternatively or in addition, the memory 1304 may be separate from the processor 1302, such as a cache memory of a processor, the system memory, or other memory. The memory 1304 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 1304 may be operable to store instructions 1324 executable by the processor 1302. The functions, acts or tasks illustrated in the figures or described herein may be performed by the programmed processor 1302 executing the instructions 1324 stored in the memory 1304. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 1300 may further include a display 1314, such as a liquid crystal display (LCD), an organic light emitting diode (OLED), a flat panel display, a solid state display, a cathode ray tube (CRT), a projector, a printer or other now known or later developed display device for outputting determined information. The display 1314 may act as an interface for the user to see the functioning of the processor 1302, or specifically as an interface with the software stored in the memory 1304 or in the drive unit 1306.

Additionally, the computer system 1300 may include an input device 1312 configured to allow a user to interact with any of the components of system 1300. The input device 1312 may be a number pad, a keyboard, or a cursor control device, such as a mouse, or a joystick, touch screen display, remote control or any other device operative to interact with the system 1300.

The computer system 1300 may also include a disk or optical drive unit 1306. The disk drive unit 1306 may include a computer-readable medium 1322 in which one or more sets of instructions 1324, e.g. software, can be embedded. Further, the instructions 1324 may perform one or more of the methods or logic as described herein. The instructions 1324 may reside completely, or at least partially, within the memory 1304 and/or within the processor 1302 during execution by the computer system 1300. The memory 1304 and the processor 1302 also may include computer-readable media as discussed above.

The present disclosure contemplates a computer-readable medium 1322 that includes instructions 1324 or receives and executes instructions 1324 responsive to a propagated signal; so that a device connected to a network 235 may communicate voice, video, audio, images or any other data over the network 235. Further, the instructions 1324 may be transmitted or received over the network 235 via a communication interface 1318. The communication interface 1318 may be a part of the processor 1302 or may be a separate component. The communication interface 1318 may be created in software or may be a physical connection in hardware. The communication interface 1318 may be configured to connect with a network 235, external media, the display 1314, or any other components in system 1300, or combinations thereof. The connection with the network 235 may be a physical connection, such as a wired Ethernet connection or may be established wirelessly as discussed below. Likewise, the additional connections with other components of the system 1300 may be physical connections or may be established wirelessly. In the case of a service provider server 240, a third party server 250, an advertising services server 260, the servers may communicate with users 120A-N through the communication interface 1318.

The network 235 may include wired networks, wireless networks, or combinations thereof. The wireless network may be a cellular telephone network, an 802.11, 802.16, 802.20, or WiMax network. Further, the network 235 may be a public network, such as the Internet, a private network, such as an intranet, or combinations thereof, and may utilize a variety of networking protocols now available or later developed including, but not limited to TCP/IP based networking protocols.

The computer-readable medium 1322 may be a single medium, or the computer-readable medium 1322 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 1322 may include a solid-state memory such as a memory card or other package that houses one or more non-volatile read-only memories. The computer-readable medium 1322 also may be a random access memory or other volatile re-writable memory. Additionally, the computer-readable medium 1322 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively or in addition, virtual computer system processing maybe constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

It will be appreciated by one skilled in the art that the concept/definition of what is “safe” is implementation dependent and may be subjective and vary within the context of the implementation or execution of the disclosed embodiments, within the context of the user's desires, perceptions and/or considerations, and/or within the context of an administrative, governmental, legal or regulatory regime or consideration thereunder, and all such definitions are contemplated. In one embodiment, an interface may be provided which permits the definition, such as through one or more processing rules, of what is considered “safe” and “unsafe”, e.g. actionable, by the disclosed embodiments as discussed herein. This interface may be made available to the entity operating the disclosed embodiments, an administrative, government or regulatory actor, the user, or a combination thereof. The interface may further permit definitions of “safe” and “unsafe” on a global and/or user or organizational level whereby the disclosed embodiments operate in accordance with the particular applicable definition on a case by case basis.

The Abstract is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

We claim:

1. A method for providing safe web based interactions, the method comprising:
receiving a request from a user for a web page provided by a third party server;
retrieving the web page requested by the user;
processing the web page to determine if malicious data is associated with the web page;
disabling the malicious data associated with the web page where the malicious data is determined to be associated with the web page;
modifying the web page so that subsequent interactions with the web page by the user are redirected through a main server; and
providing the modified web page to the user.

2. The method of claim 1 wherein disabling the malicious data associated with the web page comprises at least one of: removing the malicious code associated with the web page and neutralizing the malicious code associated with the web page.

3. The method of claim 1 wherein the steps of retrieving the web page, processing the retrieved, processing the web page, disabling the malicious data, and modifying the web page occur before the step of receiving the request from the user.

4. The method of claim 1 wherein the modifying further comprises modifying a uniform resource located (“URL”) on the web page so that the URL redirects the user through the main server.

5. The method of claim 1 further comprising adding a first advertisement to the web page.

6. The method of claim 1 further comprising removing an advertisement from the web page.

7. The method of claim 1 wherein the malicious data comprises a malware program.

8. The method claim 1 wherein the receiving further comprises receiving the request from the user via a web capable device.

9. The method of claim 8 further comprising formatting the modified web page for proper display on the web capable device of the user prior to the providing.

10. The method of claim 1 further wherein the removing further comprises:
querying the user as to whether the malicious data should be removed from the web page;
receiving a response from the user as to whether the malicious data should be removed from the web page; and
removing the malicious data from the web page if the malicious data exists on the web page and the user's responds that the malicious data should be removed from the web page.

11. The method of claim 1 further comprising storing the modified web page in a data store.

12. A method of customizing a plurality of web pages requested by a user, the method comprising:
(a) retrieving a web page requested by a user wherein the web page comprises a plurality of third party Uniform Resource Locators (“URLs”), further wherein each of the plurality of third party URLs is associated with at least one third party server of a plurality of third party servers;
(b) storing a mapping between each third party URL and at least one main server URL of a plurality of main server URLs, wherein each main server URL references a main server;
(c) replacing each third party URL on the web page with the mapped main server URL;
(d) performing a customization on the web page; and
(e) serving the web page to the user.

13. The method of claim 12 further comprising:
(f) receiving a request from the user for a main server URL on the web page;
(g) retrieving the third party URL mapped to the main server URL;
(h) retrieving the web page referenced by the third party URL; and
(i) repeating steps (b)-(h).

14. The method of claim 12 wherein the customization comprises removing a data from the web page.

15. The method of claim 14 wherein the data comprises a malware program.

16. The method of claim 12 further comprising receiving the customization from the user.

17. The method of claim 12 wherein the retrieving further comprises receiving the request from a user via a web capable device.

18. The method of claim 17 wherein the customization comprises formatting the web page for proper display on the web capable device.

19. The method of claim 12 wherein the customization comprises adding a data to the web page.

20. A system for providing safe web based interactions, the system comprising:
a memory to store a request and a web page;
an interface connected to the memory, the interface operative to communicate with a user and a third party server; and
a processor operatively connected to the memory and the interface, the processor operative to receive the request, via the interface, from the user for the web page provided by a third party server, retrieve the web page requested by the user, process the web page to determine if malicious data is determined to be associated with the web page, disable the malicious data associated with the web page, where the malicious data is determined to be associated with the web page, modify the web page so that subsequent interactions with the web page by the user are redirected to the processor through the interface, and provide the web page to the user, via the interface.

21. The system of claim 20 further wherein the processor adds an exit mechanism to the web page, further wherein the exit mechanism, when activated, forwards the request of the user to the third party server.

22. The system of claim 20 wherein the processor removes an advertisement from the web page.

23. The system of claim 20 wherein the processor adds an advertisement to the web page.

24. The system of claim 20 wherein the malicious data comprises at least one of a malware, a virus, a worm, a Trojan horse, a rootkit, a backdoor, a spyware, a botnet, a logger, and a dialer.
